(19) United States
(12) Patent Application Publication
(10) Pub. No.: US 2009/0293918 A1
(43) Pub. Date: Dec. 3, 2009

(54) FRAME FOR CLEANING PAINT ROLLERS AND METHOD

(76) Inventor: Peter E. Wikman, Phoenix, AZ (US)

Correspondence Address: The von HELLENS LAW FIRM, LTD.;C. Robert von Hellens, 7330 N 16TH STREET, SUITE C 201, PHOENIX, AZ, 85020, US

(21) Appl. No.: 12/127,757

(22) Filed: May 27, 2008

(51) Int. Cl. B08B 3/10; B08B 13/00

(52) U.S. Cl. 134/33; 134/149

(57) ABSTRACT

A frame for supporting a paint roller during a cleaning function includes a first support for preventing migration of the paint roller in an axial direction, which first support is fixedly mounted on a shaft engagable with a chuck of an electric drill or crank to impart rotation to the frame and a second support axially displaced from the first support to serve as a mounting supporting an interior surface of the paint roller.

### BACKGROUND OF THE INVENTION

1. Field of the Invention

The present invention relates to apparatus for cleaning paint roller, and more particularly, to a frame for supporting a paint roller during immersion and rotation within a cleaning fluid.

2. Description of Related Prior Art

Paint rollers, rotatably supported upon a shaft, have been used for decades to apply paint to essentially flat surfaces in preference to the use of brushes. These paint rollers include a nap of synthetic material of varying thickness depending upon the viscosity of the paint and the smoothness of the surface to be painted. After use, the paint will dry or cure on the roller and render the roller useless.

To save the costs and inconvenience attendant purchasing replacement rollers, various efforts have been undertaken to clean the rollers of the paint residing on and within the nap. In most cases, manual cleaning is time consuming, inefficient and almost never one hundred percent effective in removing the paint. Thus, painters have a tendency to simply discard the rollers when other viable options are not present.

Various assemblies have been developed for mounting a paint roller and rotating the assembly and mounted paint roller manually or through the use of an electric drill while the assembly is immersed within a cleaning fluid. These assemblies are generally expensive to manufacture and cumbersome to use. Furthermore, the large parts count and intricacy of elements embodied render effective cleaning of the assembly difficult and/or time consuming. Therefore, there has been a tendency not to use such assemblies and simply discard the used paint rollers.

Certain of these assemblies for cleaning paint rollers are relatively expensive. Such expenses are generally not warranted in view of the limited savings associated with cleaning and reusing a paint roller.

### SUMMARY OF THE INVENTION

The present invention is a simple-to-use, low parts count and inexpensive frame for supporting a paint roller during immersion and rotation within a cleaning fluid. The frame includes a shaft mountable within the chuck of an electric drill to impart a rotational force to the shaft. A first support is adapted to engage one end of a paint roller, which support includes a lip to prevent migration of the paint roller toward the chuck. A second support is mounted on the shaft to support the lower end of the paint roller. The paint roller is slid unto the frame from the lower end of the shaft until the paint roller abuts the lip. Upon immersion of the frame supporting a paint roller in a cleaning fluid, the cleaning fluid will permeate the nap of the paint roller and compromise the bond between the paint and the nap. By applying a rotational force to the frame through use of an electric drill, the centrifugal force acting upon the paint embedded within the nap will cause migration of the paint out of the nap and result in an essentially completely cleaned paint roller. For manual cleaning a crank may be attached to or formed as part of the frame.

It is therefore a primary object of the present invention to provide a frame for supporting a paint roller during rotation of the paint roller within a cleaning fluid.

Another object of the present invention is to provide a simple and easy to clean frame for supporting a paint roller during a cleaning operation.

Still another object of the present invention is to provide paint roller supporting elements mounted on a shaft which accommodate passage of cleaning fluid therethrough during a cleaning operation.

Yet another object of the present invention is to provide a positioning element to prevent migration of a paint roller with respect to a supporting frame during a cleaning operation.

A further object of the present invention is to provide a three element frame for supporting a paint roller during a cleaning operation.

A still further object of the present invention is to provide a low-cost frame for supporting a paint roller during a cleaning operation.

A yet further object of the present invention is to provide a method for cleaning a paint roller.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates use of the present invention during a cleaning operation;

FIG. 2 is an isometric view of the components of the present invention;

FIG. 3 is an end view taken along lines 3-3, as shown in FIG. 2;

FIG. 4 is an isometric view of the variant of the present invention;

FIG. 5 is an end view taken along lines 5-5, as shown in FIG. 4;

FIG. 6 illustrates a variant of a support for a paint roller;

FIG. 7 illustrates another variant of a support for a paint roller;

FIG. 8 is an end view of the variant shown in FIG. 7;

FIG. 9 illustrates a further variant of a support for a paint roller;

FIG. 10 illustrates a yet further variant of a support for a paint roller;

FIG. 11 is a top view taken along lines 11-11, as shown in FIG. 10;

FIG. 11A is a side elevational view of the first support shown in FIG. 10;

FIG. 12 illustrates a yet further variant of a support for a paint roller;

FIG. 13 is an elevational view taken along lines 13-13, as shown in FIG. 12;

FIG. 13A is a side view of the first support shown in FIG. 12;

FIG. 14 is a yet further variant of a support for a paint roller;

FIG. 15 is a side view of the first support shown in FIG. 14;

FIG. 16 illustrates a still further variant of a support for a paint roller;

FIG. 17 is a side view of the first support shown in FIG. 16;

FIG. 18 is an end view of a variant first support for a paint roller;

FIG. 19 is a cross-sectional view taken along lines 19-19, as shown in FIG. 18;

FIG. 20 is an end view of a further variant of the first support for a paint roller; and

FIG. 21 is a cross-sectional view taken along lines 21-21, as shown in FIG. 20.

### DESCRIPTION OF THE PREFERRED EMBODIMENT

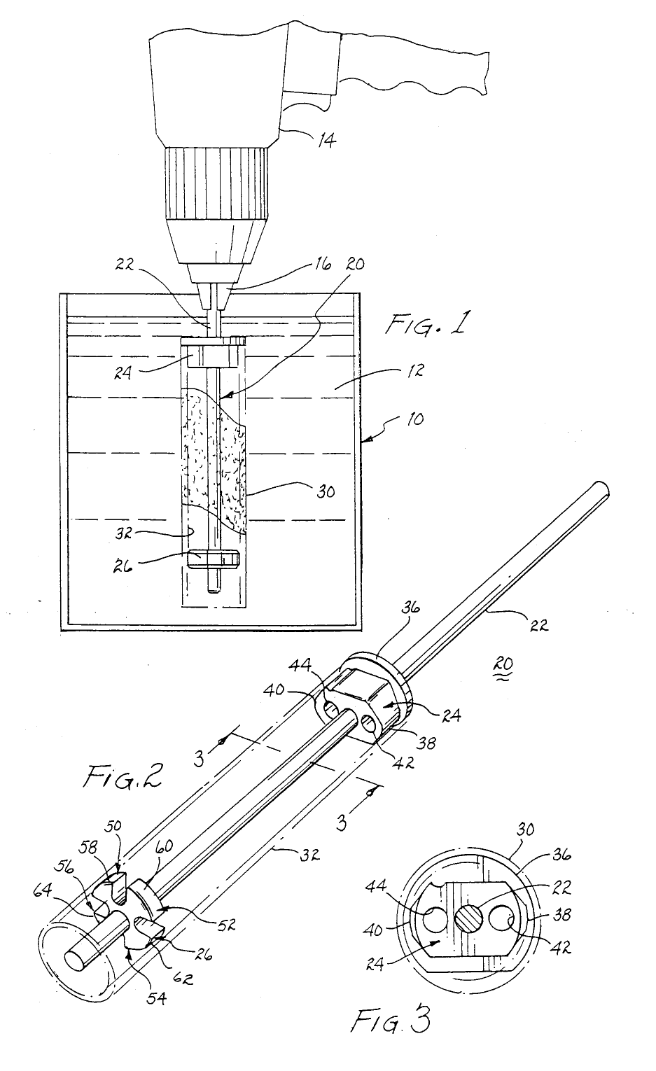

Referring to FIG. 1, there is illustrated a container 10 having a paint cleaning fluid 12 deposited therein. A conventional manual electric drill 14 includes a conventional chuck 16 for griping and releasing a shaft. A frame 20 includes a shaft 22 for griping engagement with chuck 16, as illustrated. A first support 24 and a second support 26 are fixedly mounted to shaft 22. These two supports provide a mounting for the cylindrical base of a conventional paint roller 30.

In operation, frame 20 is fixed within chuck 16 before or after paint roller 30 is mounted on the frame. Upon insertion of the frame and mounted paint roller within fluid 12, the fluid will permeate the nap of the paint roller to enhance separation of any paint clinging to the nap or the underlying roller. Upon activating drill 14, frame 20 will spin and impart a commensurate spinning rotation to paint roller 30. The resulting centrifugal force acting upon any residual paint in the nap or on the roller of the paint roller will cause radial migration of the paint. Such migration will have the effect of cleaning the paint roller of any residual paint.

While it is likely that a painter will use an electric drill to spin frame 20 and its variants, a manually operated crank, or the like, can be attached to or formed as part of shaft 22 to effect spinning motion.

Referring jointly to FIGS. 2 and 3, details of frame 20 will be described. Shaft 22, which may be a conventional shaft of steel or other material and approximately a quarter inch in diameter has a first support 24 fixedly attached thereto. The support includes a lip 36, which may be in the nature of a disc, of a diameter greater than the internal diameter of cylinder 32 of paint roller 30. Thereby, the paint roller will be precluded from movement past lip 36 along the longitudinal axis of shaft 22. First support 24 includes surfaces 38, 40 for supporting diametrically opposed areas on the interior surface of cylinder 32. Preferably, the distance between surfaces 38, 40 is at least the same as the interior diameter of cylinder 32 to ensure a frictional engagement therebetween and consequent rotation of the cylinder commensurate with the rotation of frame 20. One or more passageways, such as passageways 42, 44 extend through the first support to permit flow therethrough of cleaning fluid.

Second support 26 is fixedly mounted to shaft 22 a distance from the first support which is equal to or less than the length of cylinder 32 of paint roller 30. The main purpose of the second support is that of supporting the paint roller concentric with shaft 22. The second support includes one or more arms, of which arms 50, 52, 54 and 56 are shown, for engagement with the interior surface of cylinder 32. To enhance engagement and to provide support, peripheral surfaces 58, 60, 62 and 64 may define sections of a cylindrical surface commensurate with the curvature of the interior surface of cylinder 32. Thereby, sufficient support is provided to prevent wobbling of the cylinder (and paint roller) on frame 20. As arms 50, 52, 54 and 56 are displaced from one another, the spaces therebetween accommodate a flow of cleaning fluid. Thereby, the passageways within the first support in combination with the spaces in the second support permit flow of cleaning fluid through cylinder 32 to enhance dislodgement of any residual paint and cleaning of the paint roller.

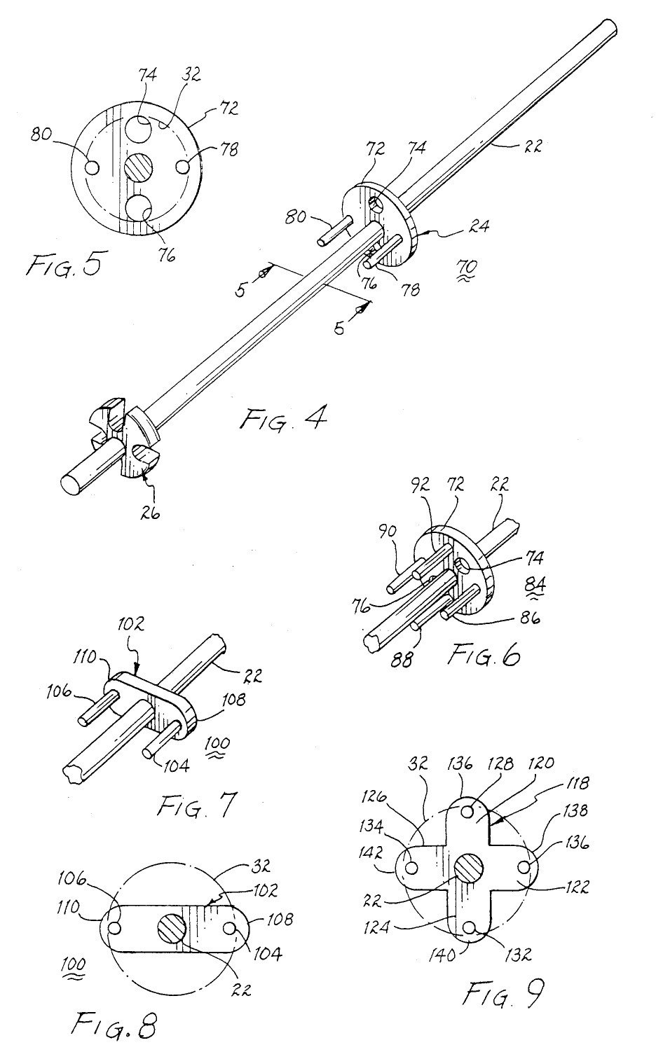

FIGS. 4 and 5 illustrate a variant frame 70. This frame includes shaft 22 supporting second support 26, as described above. First support 24 includes a fixedly attached disc 72. This disc may include one or more passageways 74, 76 to accommodate flow of cleaning fluid into and out of the cylinder of a paint roller mounted upon the variant frame. The cylinder (see FIG. 2) is mounted upon pins 78,80 extending from disc 72. Preferably, the distance between the respective radially outward surface sections of these pins is the same as or greater than the interior diameter of the cylinder of the paint roller to ensure frictional engagement therebetween and rotation of the paint roller commensurate with rotation of shaft 22. As some slippage of the cylinder with respect to the pins is expected, it is preferable to have pins 78, 80 made of wear-resistant material, such as hardened steel.

FIG. 6 illustrates a variant 84 of first support 24 shown in FIG. 4. Variant 84 includes a disc 72 having passageway 74, 76 form therein, as described above. Four pins 86, 88, 90 and 92 are engaged with and extend from disc 72 to provide support for cylinder 32 (see FIG. 2) at two pairs of diametrically opposed locations. Such multiple contacts between the pins and the cylinder provide not only support but additional friction to prevent rotation of the paint roller independent of rotation of frame 20. It may be noted that disc 72, in each of the embodiments shown in FIGS. 4, 5 and 6 serve in the manner of a lip to prevent migration of the paint roller toward drill 14 during spinning of the paint roller.

FIGS. 7 and 8 illustrate a further variant 100 of first support 24. A bar 102 is fixedly attached to shaft 22. A pair of pins 104, 106 extend from proximate opposed ends of the bar to provide support for cylinder 32 (see FIG. 2). As discussed above, these pins may be of hardened steel to minimize wear due to slippage of the cylinder upon the rollers. Opposed ends 108, 110 of bar 102 extend beyond pins 104, 106 respectively. These extended ends serve in the manner of a lip (as discussed above) to prevent migration of cylinder 32 toward the drill. As bar 102 does not extend across the fill internal diametric space of cylinder 32, the resulting spaces between the bar and the interior surface of the cylinder accommodate a flow of cleaning fluid into and out of the cylinder during a cleaning operation.

FIG. 9 illustrates a further variant 116 of first support 24. In this variant, a cruciform element 118 includes four arms 120, 122, 124 and 126. Each of these arms supports one of pins 128, 130, 132 and 134. The diametric distance between pairs of these pins is essentially commensurate with the internal diameter of cylinder 32 (see FIG. 2) to provide support for the cylinder and sufficient friction to minimize rotation of shaft 22 independent of the cylinder. As set forth above, each of these pins may be of hardened steel or other low-wear material. Ends 136, 138, 140 and 142 of arms 120, 122, 124 and 126, respectively, extend radially beyond the respective pins and serve in the manner of lips to prevent migration of cylinder 32 toward the drill during rotation of shaft 22.

FIG. 10 illustrates a variant 150 of a support for a paint roller. Second support 26, mounted on shaft 22, is similar to that described above. The first support 24, shown as a bar 152, is mounted on shaft 22 and will be described in further detail with reference to FIGS. 11 and 11A. The bar includes an essentially rectangular body 154 with tabs 156, 158 extending from opposed ends thereof. Tabs 156, 158 include ramps 160, 162 for guiding the body of a paint roller (see for example FIG. 2) onto tabs 156, 158. Preferably, the dimension between the ends of the tabs is greater than the diameter of the body of the paint roller in order to cause the body of the paint roller to be jammed thereon to a sufficient degree to restrain independent rotation between the paint roller and bar 152. To assist in withdrawal of the paint roller from engagement with bar 152, a slight ramp 164, 166 may be formed at the upper end (as illustrated in FIG. 11) of tabs 156, 158. Without such further ramps, there may be a possibility that a sharp edge would dig into or otherwise mechanically interfere with the interior surface of the body of the paint roller and render more difficult removal of the paint roller.

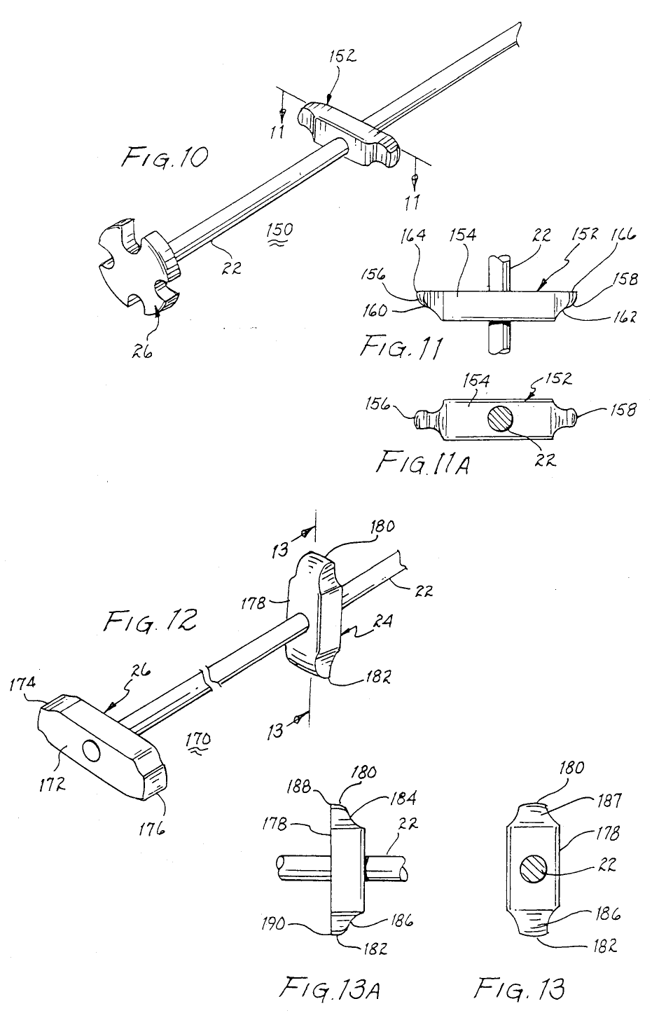

FIGS. 12, 13 and 13A illustrate yet another variant 170 and illustrating differently configured first and second supports 24, 26, respectively, mounted upon shaft 22. Second support 26 is essentially a bar 172 secured to shaft 22. The bar includes opposed ends 174, 176 formed as segments of a cylinder to conform with the interior cylindrical surface of a paint roller upon contact therebetween. First support 24 includes a central bar 178 fixedly attached to shaft 22. Ends 180, 182 include ramps 184,186 for guiding the interior of a paint roller onto first support 24. As particularly illustrated in FIG. 13, ends 180, 182 may define segments of a cylinder in radial conformance with the curvature of the interior surface of the paint roller. Preferably, the distance between ends 180, 182 is greater than the diameter of the interior surface of the paint roller in order to cause the paint roller to compressibly grip the first support. It may be noted that as the paint roller is slide upon first support 24, it will be guided by ramps 184, 186 and caused to stretch to a certain degree. The resulting frictional interaction between first support 24 and the interior surface of the paint roller will restrain independent rotational movement therebetween. Edge 188, 190 may be sharp, as illustrated in FIG. 13A, to interfere, to some degree, with sliding removal of the paint roller off first support 24. Thus, retention of the paint roller will be enhanced. However, depending upon the material and degree of resiliency of the paint roller, it may be preferable to provide small ramped surfaces instead of a sharp edge, as illustrated and discussed above with respect to the first support shown in FIG. 11.

FIG. 14 illustrates a yet further variant 196 wherein a second support 26 is like that discussed above and illustrated in various of the Figures. First support 24 is a plate 198 having opposed ends 200, 202 defining ramps 204, 206 to facilitate mounting the paint roller upon the first support. To assist in providing sufficient friction between the first support and the paint roller, ramps 204, 206 may be segments of a cylindrical surface having an axis essentially orthogonal to the axis of shaft 22. Edges 208, 210 may be sharp, as illustrated in FIG. 15, to cause mechanical interference with the interior surface of the paint roller and thereby prevent inadvertent dismounting of the paint roller from the first support during a cleaning operation. However, by manually squeezing the paint roller in an axis orthogonal to an axis extending through cylindrical surfaces 204, 206, withdrawal of the paint roller from the first support will be enhanced. Alternatively, these edges may be in the nature of ramps, as shown in FIG. 11.

Another variant 210 is shown in FIGS. 16 and 17. Herein, second support 26 is mounted upon shaft 22, as described above. First support 24 is similar in configuration to bar 178 described in respective FIGS. 12, 13 and 13A. However, ends 180, 182 may include a step-like ramp, as illustrated to facilitate insertion of the first support into one end of a paint roller. Moreover, edges 212, 214 may be beveled or ramp-like to facilitate dismounting the paint roller from bar 178. Furthermore, the sides of each of ends 180, 182 may be scalloped, as illustrated.

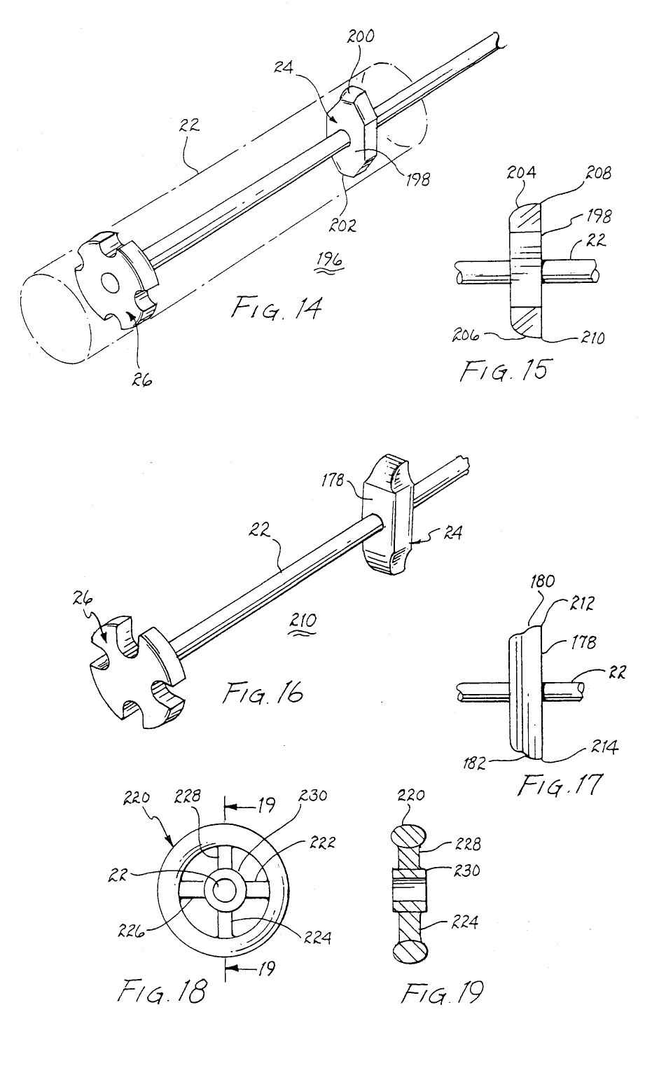

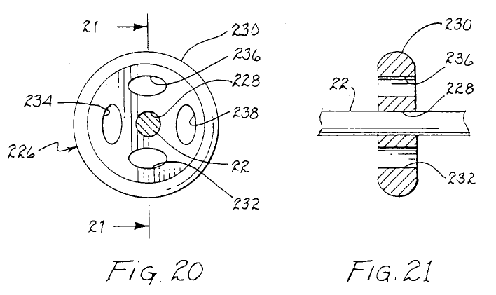

FIGS. 18 and 19 illustrate a first support in the nature of a ring 220. The ring includes a plurality of spokes, of which spokes 222, 224, 226 and 228 are illustrated. These spokes extend from a cylinder 230 for fixedly receiving shaft 22 extending therethrough. As particularly shown in FIG. 19, ring 220 may be oval in cross section, as illustrated. Such configuration guides the interior surface of a paint roller onto and past ring 220. As the diameter of the ring is reduced on either side of the diametric maximum of the ring, a certain degree of contraction of the edge of the paint roller, when slid past ring 220, may occur to assist in retaining the paint roller on ring 220. It is to be understood that ring 220 serves in the manner of the first support described in various embodiments above. The second support mounted on shaft 22 may be of any of the configurations discussed above or of a different configuration and configured to prevent wobble of the paint roller.

Instead of a ring 220, as shown in FIG. 15, the second support may be like that shown in FIG. 19. That is, the second support may include cylinder 230 and spokes 224, 228. Instead of a ring, a ring segment may be supported upon each spoke to serve the purpose of supporting one end of the paint roller in the manner of ring 220.

FIGS. 20 and 21 illustrate a further variant 226 of first support 24 that provides a retention capability for maintaining the paint roller on frame 20. The variant is fixedly attached to shaft 22 through passageway 228. The variant is in the nature of a disk having a curved or ramped edge 230 for accommodating sliding movement of the interior surface of the paint roller thereupon and there past. Preferably, the diameter at the apex of edge 230 is greater than the interior diameter of the paint roller to cause extension of the part of the paint roller in contact therewith upon sliding movement of the paint roller onto variant 226. Thereby, tensile forces are circumferentially imposed in the paint roller that result in gripping with and a frictional interface with the variant to retain the paint roller thereupon without significant relative movement during rotation of frame 20 about the axis of shaft 22. A plurality of apertures 232, 234, 236 and 238 are formed in variant 226 to accommodate flow of cleaning fluid into and out of the interior of the paint roller during a cleaning operation. The size, configuration and number of these apertures are a function of the desired volume and flow rate of cleaning fluid therethrough. The second support for the paint roller may be of any of the configurations described above in order to prevent wobble of the paint roller during rotation of frame 20.

I claim:

1. A frame to evacuate by centrifugal force any residual paint that may be present on the paint roller, said frame comprising in combination:
a) a shaft;
b) a first support mounted on said shaft for supporting one end of the paint roller, said first support including a lip for preventing migration of the paint roller past said first support;
c) at least one passageway disposed in said first support for accommodating flow of the cleaning fluid into and out of the interior of the paint roller;
d) a second support mounted on said shaft at a distance from said first support for supporting the paint roller; and
e) at least one passageway extending through said second support for accommodating flow of the cleaning fluid into and out of the interior of the paint roller.

2. The frame as set forth in claim 1, including a pair of diametrically opposed surfaces of said first support for supporting the paint roller.

3. The frame as set forth in claim 1, including at least two surfaces of said first support for supporting the paint roller.

4. The frame as set forth in claim 1, wherein said second support includes at least two arms for supporting the paint roller.

5. The frame as set forth in claim 1, wherein said second support includes four equiangularly oriented arms for supporting the paint roller.

6. The frame as set forth in claim 1, wherein said first support includes a disc and at least two pins extending from said disc for supporting the paint roller.

7. The frame as set forth in claim 1, wherein said first support includes a bar and a pair of pins extending from said bar for supporting the paint roller.

8. The frame as set forth in claim 1, wherein said first support includes four arms in cruciform shape and a pin extending from each arm of said four arms for supporting the paint roller.

9. A frame for cleaning a paint roller, said frame comprising in combination:
a) a shaft adapted for engagement by the chuck of an electric drill;
b) a first support mounted on said shaft for engaging the interior of one end of the paint roller, said first support including opposed ends defining a distance therebetween greater than the dimension of the interior diameter of the paint roller for preventing migration of the paint roller toward or away from the chuck;
c) a second support mounted on said shaft at a distance from said first support for engaging the interior of the paint roller, said second support including at least one passageway extending through said second support.

10. The frame as set forth in claim 9, including a diametrically opposed ramped surface disposed on each of said ends of said first support for supporting the paint roller.

11. The frame as set forth in claim 9, wherein said second support includes at least two arms for supporting the paint roller.

12. The frame as set forth in claim 9, wherein said first support includes a bar supported on said shaft, said bar including ramped surfaces for facilitating insertion and removal of said first support from within the paint roller.

13. The frame as set forth in claim 9, wherein said first support includes a plate and a pair of ramped surfaces for supporting the paint roller.

14. The frame as set forth in claim 9, wherein said first support includes a cylinder for attachment to said shaft, spokes extending from said cylinder and a ring supported by said spokes for supporting the paint roller.

15. The frame as set forth in claim 14, wherein each spoke of said spokes supports a segment of a ring.

16. The frame as set forth in claim 14, wherein the outside diameter of said ring is greater than the interior diameter of the paint roller.

17. The frame as set forth in claim 16, wherein the cross section of said ring is oval.

18. A method for cleaning a paint roller in a container of cleaning fluid, said method comprising the steps of:
a) sliding the paint roller onto a frame having first and second supports mounted on a common shaft;
b) expanding the interior of the paint roller upon engagement with the second support to prevent migration of the paint roller during rotation of the frame;
c) inserting the frame and paint roller mounted thereon into the container of cleaning fluid;
d) accommodating flow of cleaning fluid through the first and second supports into and out of the interior of the paint roller;
e) rotating the frame about the axis of the shaft to urge discharge of paint from the paint roller in response to the imposed centrifugal force.

19. The method as set forth in claim 18, wherein the second support includes ramped surfaces to facilitate said step of sliding one end of the paint roller onto the second support.

20. The method as set forth in claim 18, wherein one of the supports includes at least two arms and wherein said step of sliding includes the step of sliding the paint roller onto the two segments of a ring.

21. A frame for cleaning a paint roller, said frame comprising in combination:
a) a shaft adapted for engagement by the chuck of an electric drill;
b) a first support mounted on said shaft for engaging the interior of one end of the paint roller, said first support including a disc having a diameter greater than the dimension of the interior diameter of the paint roller for preventing migration of the paint roller toward or away from the chuck, said disc including at least one passageway;
c) a second support mounted on said shaft at a distance from said first support for engaging the interior of the paint roller, said second support including at least one passageway extending through said second support.

22. The frame as set forth in claim 21, wherein said disc includes a curved edge defining the perimeter of said disc.
